(19) United States
(12) Patent Application Publication
(10) Pub. No.: US 2026/0242011 A1
(43) Pub. Date: Aug. 20, 2026

(54) MECHANISM FOR MOVABLY MOUNTING AN UPPER STRUCTURE OF AN OFF-ROAD VEHICLE WITH RESPECT TO A CHASSIS OF THE OFF-ROAD VEHICLE

(71) Applicant: Deere & Company, Moline, IL (US)

(72) Inventor: PEETU VALKAMA, Pinsiö (FI)

(21) Appl. No.: 19/445,082

(22) Filed: Jan. 9, 2026

(30) Foreign Application Priority Data
Feb. 20, 2025 (EP) 25159094.9

(51) Int. Cl. B62D 33/067; A01G 23/00; B62D 33/06; B62D 33/063

(52) U.S. Cl. CPC B62D 33/067; A01G 23/003; B62D 33/0608; B62D 33/0617; B62D 33/0633; B62D 33/0636; B60Y 2200/222

(57) ABSTRACT

A mechanism for movably mounting an upper structure of an off-road vehicle with respect to a chassis comprises a first part, a second part, a first linear actuator, a second linear actuator, a third linear actuator, a first link, and a second link. The first part is connected to the chassis or the upper structure. The second part is connected to the upper structure or the chassis. The linear actuators are connected by the spherical joints to the first and second parts. The first and second actuator are spaced in a first direction with a third linear actuator spaced in a second direction transverse to the first direction. A first link is connected between the first part and the second part and pivots on a first end around an axis parallel to the first direction. A second link is configured to restrict rotation against the first part within the plane.

### CROSS REFERENCE TO RELATED APPLICATIONS

The application claims priority under 35 U.S.C. § 119 to European patent application EP 25159094.9, filed on 20 Feb. 2025, the disclosure of which is incorporated herein by reference.

### TECHNICAL FIELD

The present disclosure relates to a mechanism for movably mounting an upper structure of an off-road vehicle with respect to a chassis of the off-road vehicle.

### BACKGROUND

Off-road vehicles are designed to operate on uneven terrain. This means the ground does not need to be flat; it may be sloped such that the vehicle, through its ground-engaging means, contacts a surface inclined in two directions—laterally and forward. Accordingly, the ground-engaging means of the vehicle can lie in a plane having a roll angle in the lateral direction and a pitch angle in the forward direction. Examples of such off-road vehicles include forestry machines, such as harvesters and forwarders. Agricultural and construction vehicles, such as tractors and excavators, may also need to operate on similar terrain. Forested areas, agricultural fields, and construction sites are often uneven and typically do not form a homogeneous surface.

In current approaches, off-road vehicles have been provided with a chassis that includes the ground-engaging means and an upper structure adjustable relative to the chassis in at least one direction. The upper structure may comprise only an operator cabin or may also include work elements, such as an excavator boom. A position-adjustable mechanism is provided between the chassis and the upper structure of the off-road vehicle. This mechanism allows the upper structure to be maintained in a desired orientation, particularly in a leveled position with respect to gravity, and/or provides damping for the upper structure

Reference is made to the prior art described in EP 0 994 009 A1, which discloses a mechanism with four actuators positioned between the chassis and the four corners of a tractor cabin. Each actuator adjusts the vertical position of its respective cabin corner relative to the chassis. In this design, the actuators not only provide vertical support for the cabin but also must accommodate horizontal forces. Because the actuators are movable only in the vertical direction relative to the chassis (when the chassis is oriented exactly horizontal), elastic elements are provided between the actuators and the cabin to absorb horizontal movement between the upper end of the actuator and the cabin. This mechanism is therefore suitable only for small angular adjustments. Furthermore, it presents safety concerns because, in the event of a rollover or collision, the cylinders must absorb the entire impact energy.

Other mechanisms have been described, for example, in WO 99/01329 A1, EP 2 058 438 A2, and US 2009/0152025 A1, in which an intermediate part is positioned between a lower part connected to the chassis and an upper part connected to the cabin. The intermediate part is pivoted to the lower part about a first horizontal tilt axis and to the upper part about a second horizontal tilt axis oriented at 90° to the first. The angles about both tilt axes are controlled by two actuators for each axis, respectively.

WO 94/16155 A1 discloses another mechanism for tilting an upper structure of an off-road vehicle relative to the chassis. This mechanism also includes an intermediate part positioned between a lower part connected to the chassis and an upper part connected to the upper structure. The intermediate part is connected at its rear end to the lower part by a spherical bearing and at its forward end is pivoted about a forward axis to the lower part. The upper part is pivoted about a transverse axis to the intermediate part at its forward end and, at its rear end, is connected to a cylinder that adjusts the vertical position of the rear end of the upper part. Lateral inclination of the upper part is adjusted by two counteracting cylinders that pivot the intermediate part about the forward axis. The intermediate part serves to transfer horizontal forces to the lower part, thereby relieving the pivot pin of the intermediate part from horizontal loads. Consequently, the intermediate part pivots only about the forward axis relative to the lower part, while the upper part pivots relative to the lower part about a transverse axis, allowing both tilt and roll adjustments.

Typically, the upper structure is also rotatable relative to the upper part about a vertical axis. Current mechanisms for moving the upper structure relative to the chassis of an off-road vehicle include tilting the upper structure about two orthogonal axes to compensate for roll and tilt relative to the ground.

However, the present configurations are limited in scope. Therein lies an opportunity to address the shortcomings associated with present limited forms of movement.

### SUMMARY

A mechanism for movably mounting an upper structure of an off-road vehicle with respect to a chassis comprises a first part, a second part, a first linear actuator, a second linear actuator, a third linear actuator, a first link, and a second link. The first part is connected to the chassis or to the upper structure. The second part is connected to the upper structure or the chassis. The first linear actuator is connected by spherical joints to the first part and the second part, respectively. The second linear actuator is connected by spherical joints to the first part and the second part, respectively. The first and second actuator are spaced in the first direction. A third linear actuator is connected by spherical joints to the first part and the second part, respectively, and is spaced from the first and second actuator in a second direction transverse to the first direction. The first link is with a fixed length. The first link is connected between the first part and the second part wherein the first link is configured to pivot on a first end only around an axis extending parallel to the first direction and connected with its second end by a spherical joint. The second link is connected to the first part and the second part wherein the second link restricts rotation of the second part against the first part within the plane spanned by the first and the second direction.

The second link has a fixed length and is connected to the first and second part by respective spherical joints at positions spaced in the first direction.

The mechanism may further comprise of a fourth actuator connected by spherical joints between the first part and the second part wherein the fourth actuator is spaced from the third actuator in the first direction and from the first and second actuator in the second direction.

The first link is connected to the second part at a position at the center between the spherical joints mounting the first and second actuator to the second part.

The first link is connected to the first part at a position between the spherical joints mounting the third and fourth actuator to the first part.

The second or first part comprises a support element for the upper structure wherein the support element is rotatably mounted on the second or first part around a vertical axis by a rotations actuator.

The mechanism may further comprise stops limiting axial movement of the support element with respect to the second or first part.

The first direction is transverse to a forward direction of the vehicle and the second direction extends in the forward direction of the vehicle.

A control arrangement is connected to the actuators that are configured to control at least two of the linear actuators to move jointly to control the inclination angle of the upper structure around an axis parallel to the first direction. The actuators further control at least two of the linear actuators to move in opposite directions to control the inclination angle of the upper structure around an axis parallel to the second direction and to control the linear actuators jointly to change the height of the upper structure.

The control arrangement is configured to compensate a rotation of the upper structure around the vertical axis caused by movement of at least one linear actuator and the geometry of the second link by controlling the rotation actuator.

The mechanism may further comprises stops between the first and second parts, assigned to the linear actuators and restricting the movement range of the actuators.

The mechanism may further include stops comprise a slot interacting with a pin.

The actuators are hydraulic cylinders and connected or connectable to respective pneumatic reservoirs for dampening the upper structure.

A cross section of the connection between the cylinders and the pneumatic reservoirs is variable.

The upper structure comprises of an operator cabin. An off-road vehicle, in particular a forestry vehicle like a harvester or a forwarder with a mechanism according to one of the preceding claims, wherein the upper structure comprises or consists of an operator cabin

Other features and aspects will become apparent by consideration of the detailed description, claims, and accompanying drawings.

### BRIEF DESCRIPTION OF THE DRAWINGS

The detailed description of the drawings refers to the accompanying figures.

FIG. 1 is a schematical view of an off-road vehicle with a chassis and an upper structure in the form of a cabin.

FIG. 2 is a lateral view of a mechanism for movably mounting the upper structure to the chassis of the off-road vehicle of FIG. 1.

FIG. 3 is a lateral view of the mechanism of FIG. 2, however having a smaller height.

FIG. 4 is a is a perspective, explosive view of the mechanism of FIG. 3.

FIG. 5 is a lateral view of the mechanism of FIG. 3 pivoted to the rear.

FIG. 6 is a lateral view of the mechanism of FIG. 3 pivoted to the front.

FIG. 7 is a rear view of the mechanism of FIG. 3 pivoted to the left.

FIG. 8 is a rear view of the mechanism of FIG. 3 pivoted to the right.

FIG. 9 is a lateral view of the mechanism of FIG. 3 shifted upwards.

FIG. 10 is a is a lateral view of the mechanism of FIG. 3 shifted down,

FIG. 11 is a schematic diagram of the control arrangement of the actuators of the mechanism.

FIG. 12 is a diagram showing details of the hydraulic control of the linear actuators.

### DETAILED DESCRIPTION

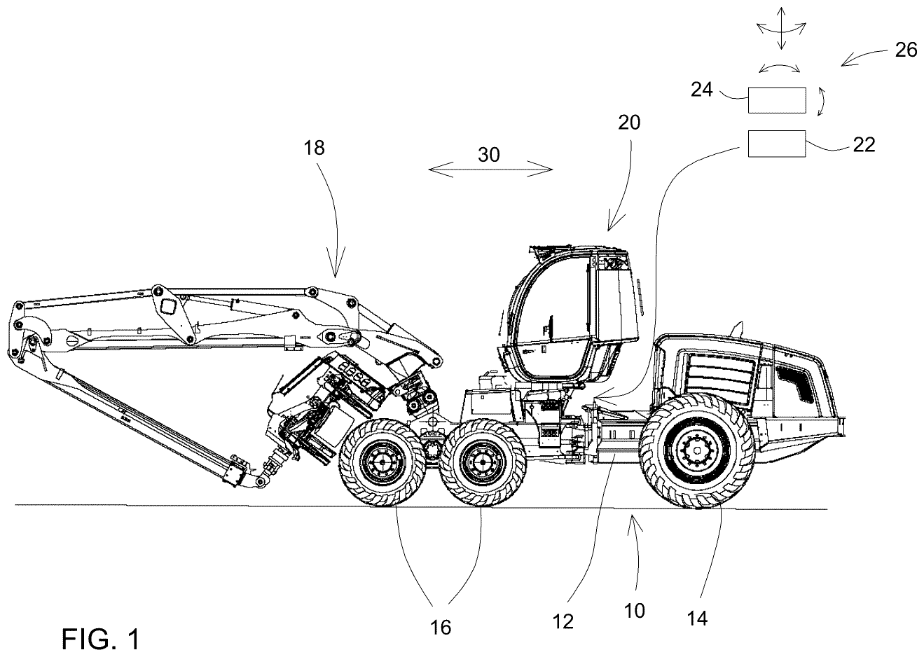

Reference is now made to FIG. 1, in which an off-road vehicle 10 is shown. The off-road vehicle 10 comprises an articulated chassis 12, supported on ground engaging means in the form of driven rear wheels 14 and front wheels 16. The chassis 12 supports on its front end a boom 18 with a harvester head for processing (felling, debarking, cutting) trees. The chassis 12 also supports an upper structure of the off-road vehicle 10 in the form of an operator cabin 20. The cabin 20 is mounted to the chassis 12 by a mechanism 26 that movably mounts the upper structure, i.e., the cabin 20, with respect to the chassis 12 of the off-road vehicle 10.

In the embodiment shown, the off-road vehicle 10 is a forestry vehicle in the form of a harvester, but it should be noted that the mechanism described herein is also suited for other types of vehicles, like construction or agricultural machines or other types of forestry machines, like forwarders. The upper structure is described here as the cabin 20 but could also or additionally comprise or consist of other parts, for example the boom 18.

Since the off-road vehicle 10 operates on uneven ground that can comprise obstacles and pits in the ground, the cabin 20 is supported on the chassis 12 in a movable (adjustable) manner such that the cabin 20 can keep in a horizontal position with respect to gravitation. The mechanism 26 comprises a first part 22 which is connected to the chassis 12 or a part thereof and a second part 24 which is connected to the cabin 20 or a part thereof. The mechanism 26, shown in the following figures and described in detail hereinafter, is arranged to tilt the second part 24 around two axes, one of which extends in the forward direction of the off-road vehicle 10 and one which extends in the lateral direction of the off-road vehicle 10, and further rotates the cabin 20 around the vertical axis (as seen by the vertical hash-dot line). This allows the operator in the cabin 20 (or an automatic control) to rotate the cabin 20 towards a region of interest. Furthermore, the mechanism 26 is adapted to adjust the vertical position of the second part 24.

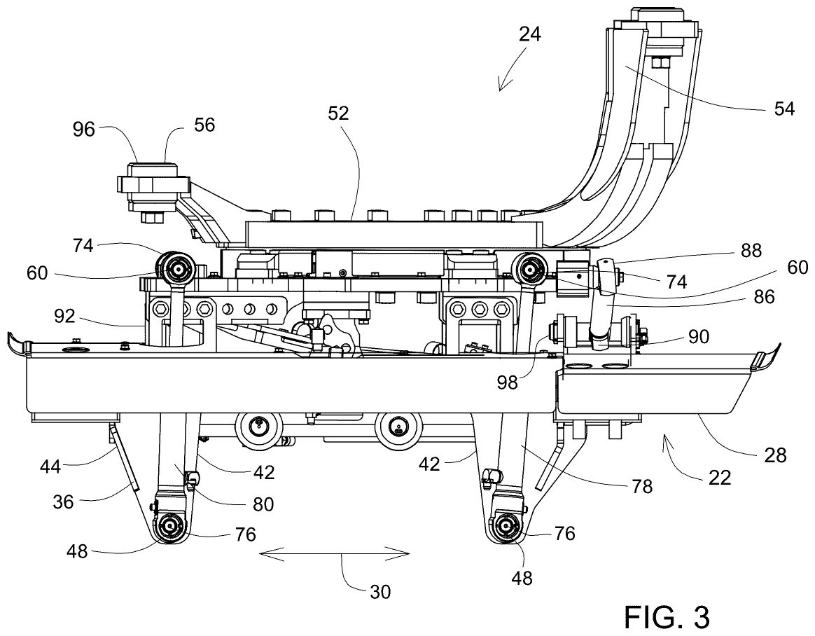

If used on a different type of vehicle, for example on a forestry forwarder instead of a harvester, the first part 22 could be replaced with a different first part 22 (as shown in FIG. 3 for a forwarder) adapted to the particular chassis of the vehicle, while the rest of the mechanism 26 would be the same as shown herein.

It should be noted that in the following figures, the second part 24 is the upper part mounted to the upper structure in the form of the cabin 20 while the first part 22 is the lower part mounted to the chassis 12, but the positions of both can be exchanged such that the first part 22 could be the upper part and the second part 24 could be the lower part.

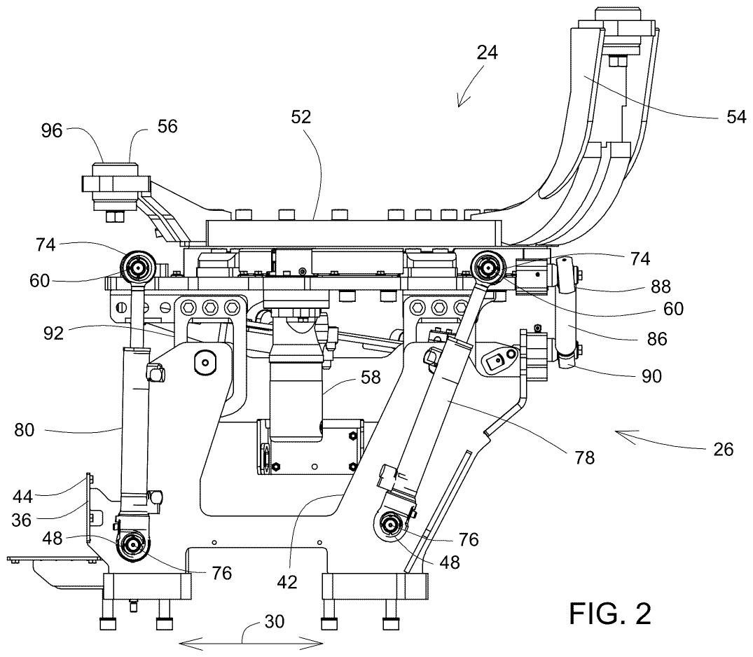

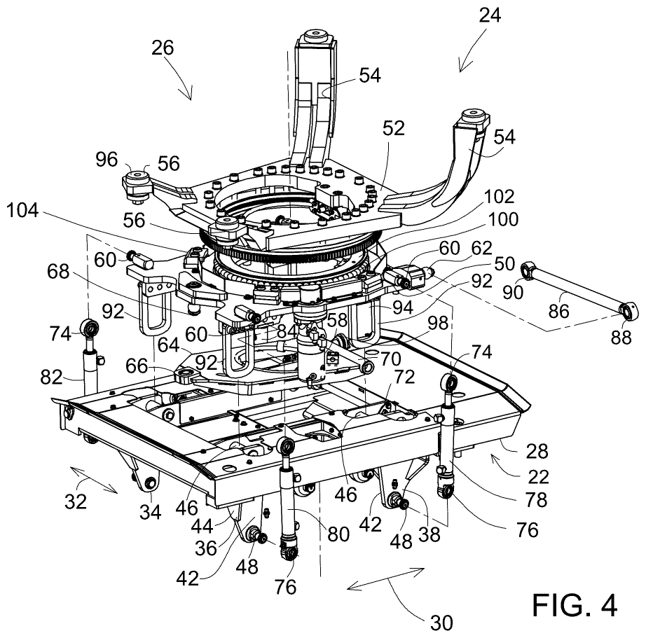

FIGS. 2 to 10 show the mechanism 26 in more detail, FIG. 2 in a lateral view and FIG. 4 in a perspective, exploded view.

The first part 22 comprises a rectangular, frame-like assembly 28 arranged in a horizontal plane with edges that extend along a first, transverse direction 32 and a second, longitudinal direction 30, which directions 30, 32 correspond to the lateral and forward direction of the vehicle 10. The assembly 28 comprises four mounting assemblies 34, 36, 38, while the fourth mounting assembly 40 is hidden and thus not visible in some of the figures. These mounting assemblies 36-40 are arranged in a rectangular pattern and spaced in the first direction 30 and second direction 32. The mounting assemblies 34-40 are located in the vicinity of the lateral edges of the assembly 28.

The mounting assemblies 34-40 each comprise two hangers 42, 44 spaced in the lateral direction and connected by upper pins 46 and lower pins 48. The lower pins 48 are thus mounted beneath the plane spanned by assembly 28 in directions 30, 32. The lower pins 48 extend horizontally and outwards from the outer hangers 42 in the first, lateral direction 32.

The second part 24 comprises a rectangular mounting plate 50 with a generally rectangular shape and arranged in the horizontal plane spanned by directions 30, 32. On the mounting plate 50 an upper, ring-shaped support element 52 is mounted to be rotatable around the vertical axis with respect to the mounting plate 50 by an actuator 58, which is preferably a hydraulic motor, allowing to rotate the cabin 20 around the vertical axis. The cabin 20 is mounted on four support elements 54, 56 that are fixed to the upper support element 52 and extend outwardly and upwardly therefrom. Between the support elements 54, 56 and the cabin 20, elastomeric elements 96 are provided. Further details on how the support element 52 is mounted on the mounting plate 50 by ball bearings 100 held by a cage 102 can be seen in FIG. 4.

On the four corners of the mounting plate 50, laterally extending pins 60 are provided. Another pin 62 extends on the rear side of the mounting plate 50 in the second direction 30, i.e., towards the rear. Further, at the forward end of the mounting plate 50, in the first direction in the center, another mounting pin holding a spherical joint 68 extend downwards.

A mechanical connection between the first and second parts 22, 24 is provided by a first link 64 and a second link 86. The first link 64 is provided in the form of a plate with a central hole accommodating the actuator 58. The first link is located in the vertical direction between the assembly 28 and the mounting plate 50, i.e., between the first and second part 22, 24 and extends between a forward end 66 holding mounting means for the spherical joint 68 and a rear end 70 extending in the first direction 32. The rear end 70 is pivotally connected to pins 72 at both sides of the assembly 28. These pins 72 are mounted on the upper end of rear inner hangers 46. Thus, the first link 64 allows the center of the second part 24 to pivot to both sides around an axis extending in the second direction 30 (around the spherical bearing 68) and to move on a circle around the axis of the pins 72 which extends in the first direction 32.

The second link 86 is a rigid rod mounted by respective spherical bearings 88, 90 to the rear pin 62 of the mounting plate 50 and to a pin 98 mounted on assembly 28. The pins 62 and 98 are on opposite lateral ends of the mechanism 26 and thus spaced in the first direction. Pin 98 extends, like pin 62 in the second direction towards the rear. The second link 86 restricts movement of the second part 24 around the vertical axis and thus prevents the second part from moving in the first direction. When the second part 24 moves vertically, there is a limited rotation thereof around the vertical axis due to the geometry of the second link 86 that can be compensated by control of actuator 58.

For position adjustment of the second part 24, in total four linear actuators 74, 76, 78 and 80 in the form of hydraulic cylinders are provided. The actuators 74-80 are mounted by lower spherical bearings 76 and upper spherical bearings 74 to the pins 48 of the lower part 22 and to the pins 60 of the upper part 24. The possible vertical movement range of the actuators 74-80 is restricted by stops 92 with slots 94 into which the upper pins 46 on the lower part 22 engage, to provide a roll-over protection structure (ROPS). Further stops 104 are provided between the mounting plate 50 and the support element 52 to limit axial movement of the support ring 50 with respect to the mounting plate 50.

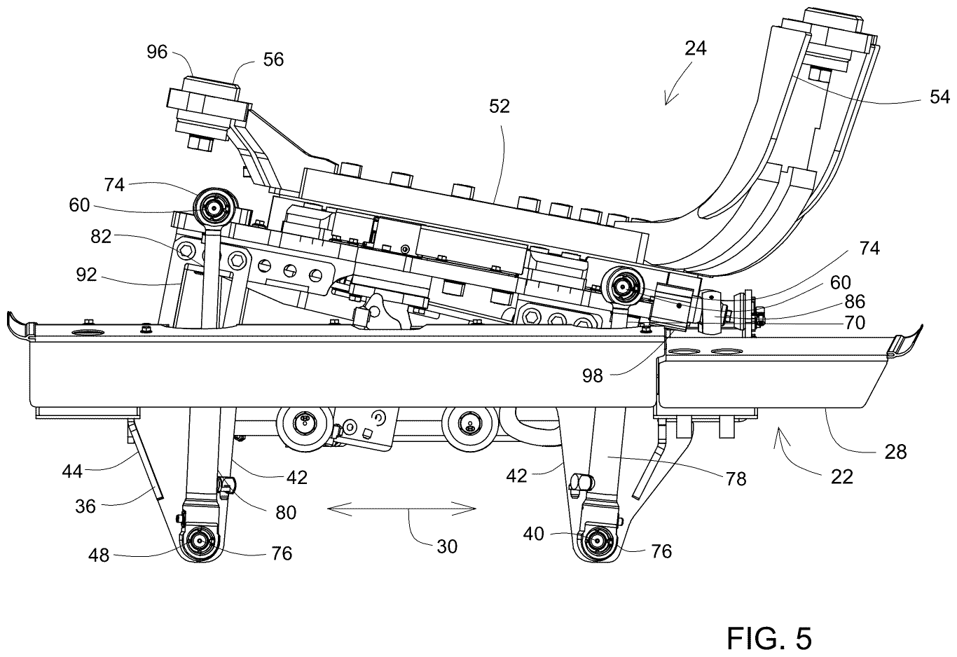

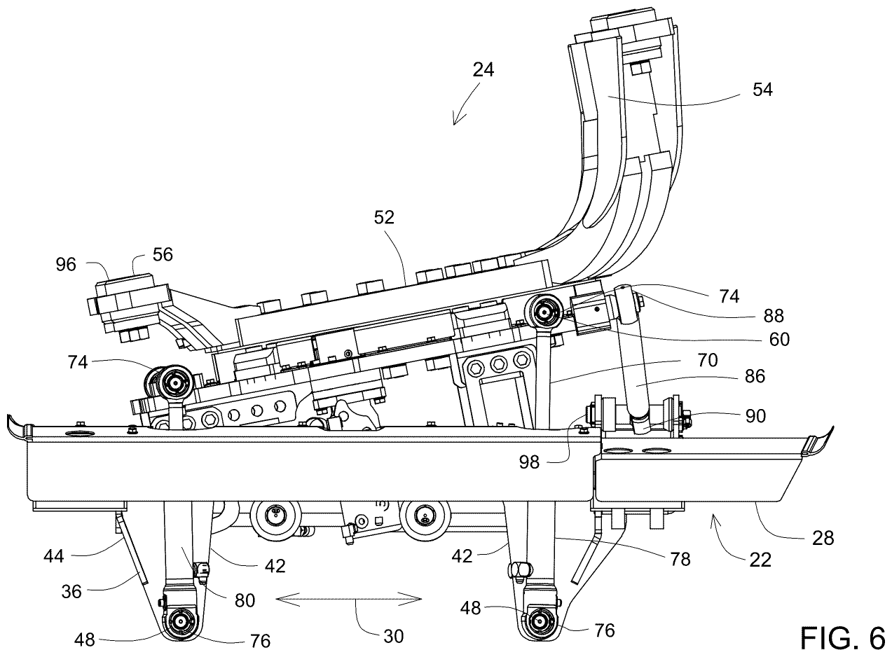

The mechanism 26 allows to tilt the upper part 24 to the front and rear, as shown in FIGS. 5 and 6, by actuating the front actuators 80, 82 and/or the rear actuators 78, 84. Thereby, the front end of upper part 24 rotates around an axis extending in the first direction 32 around pins 72, when the front actuators 80, 82 are moving. If the rear actuators 78, 84 are actuated, the front end of the upper part 24 arounds an axis extending in the first direction 32 around the spherical bearing 68.

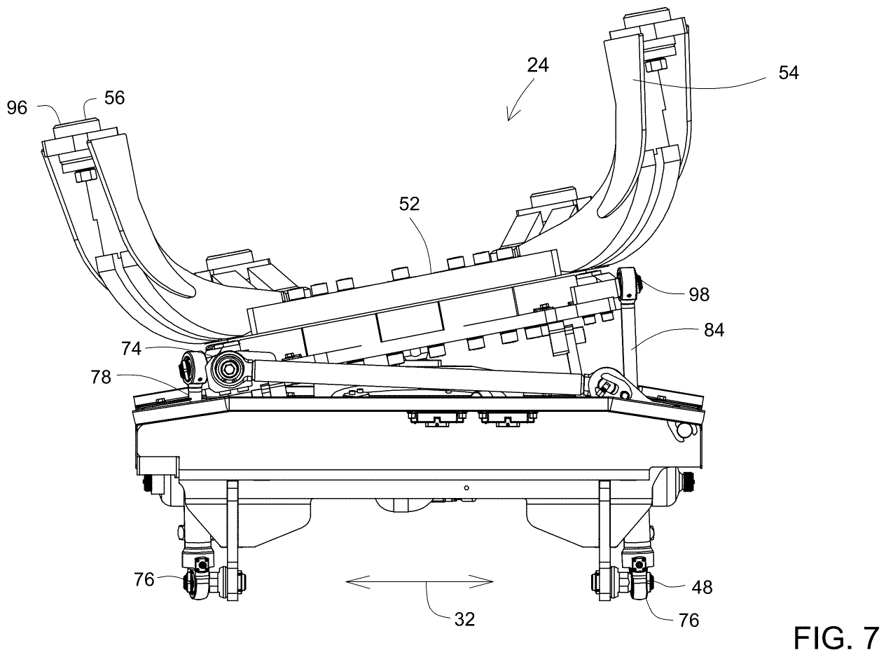

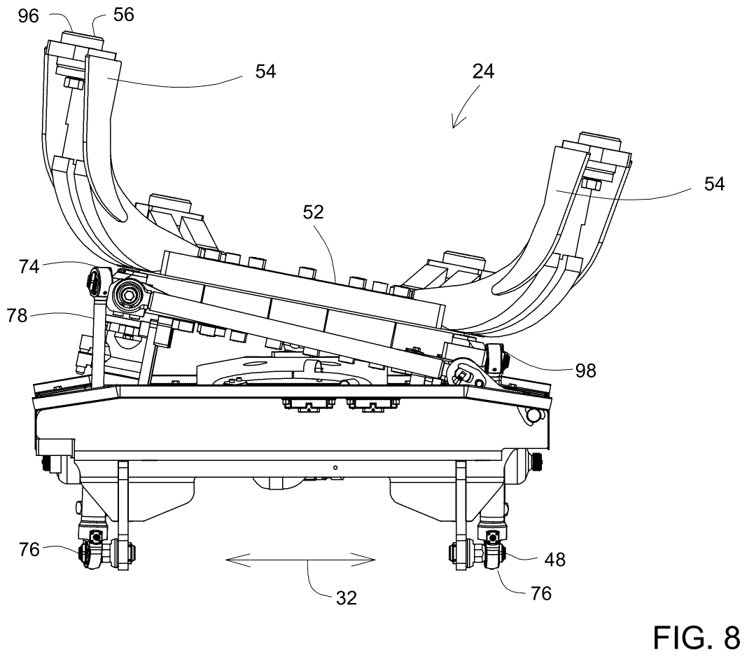

As shown in FIGS. 7 and 8, it is also possible to actuate the left actuators 78, 80 and/or the right actuators 82, 84 to tilt the upper part 24 to the left and right side. The upper part 24 then rotates around an axis extending in the second direction around the spherical bearing 68.

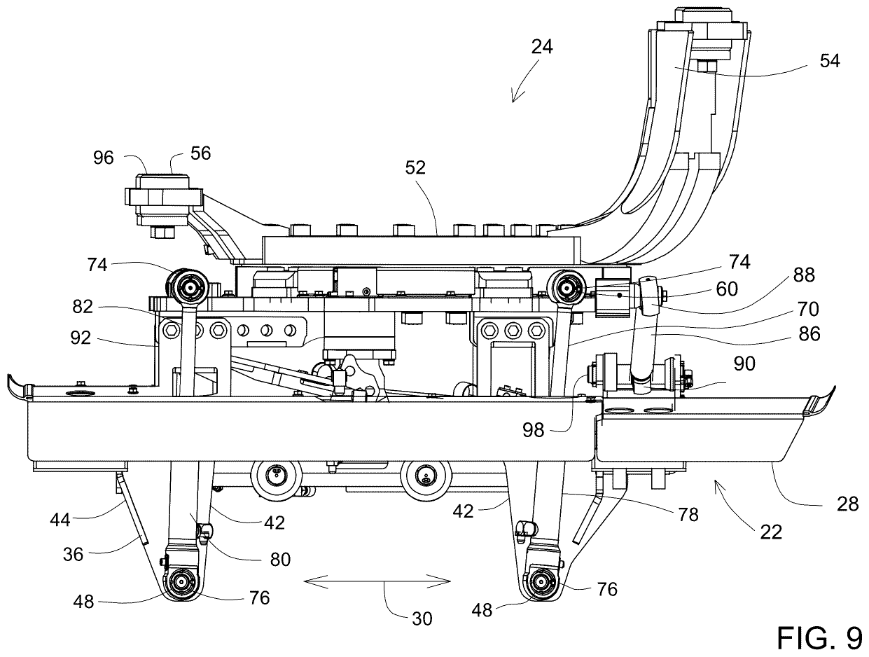

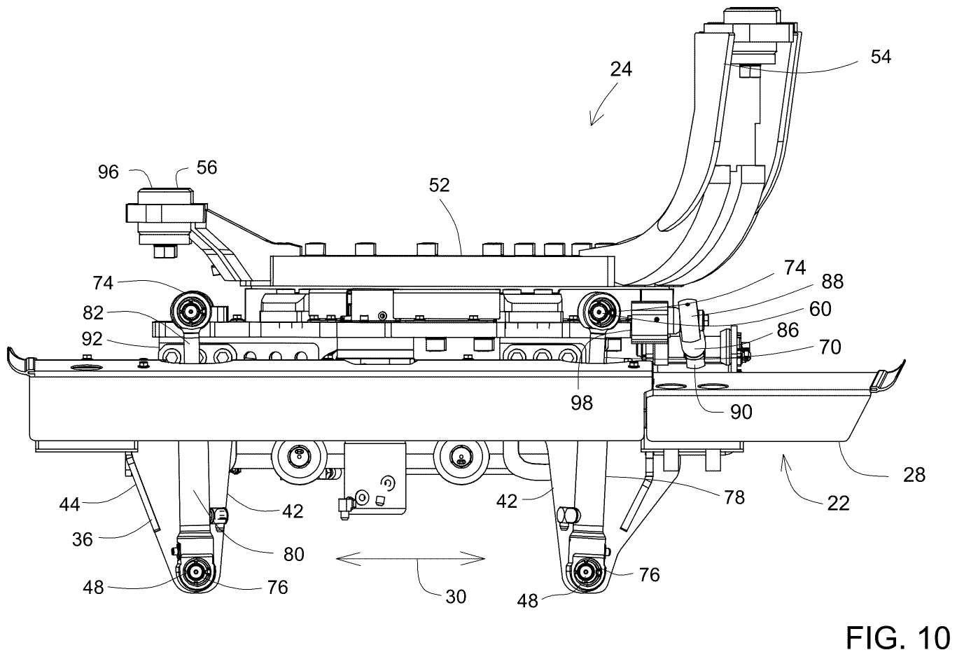

As shown in FIGS. 9 and 10, it is also possible to actuate all actuators 78-84 in unison to lift or lower the upper part 24.

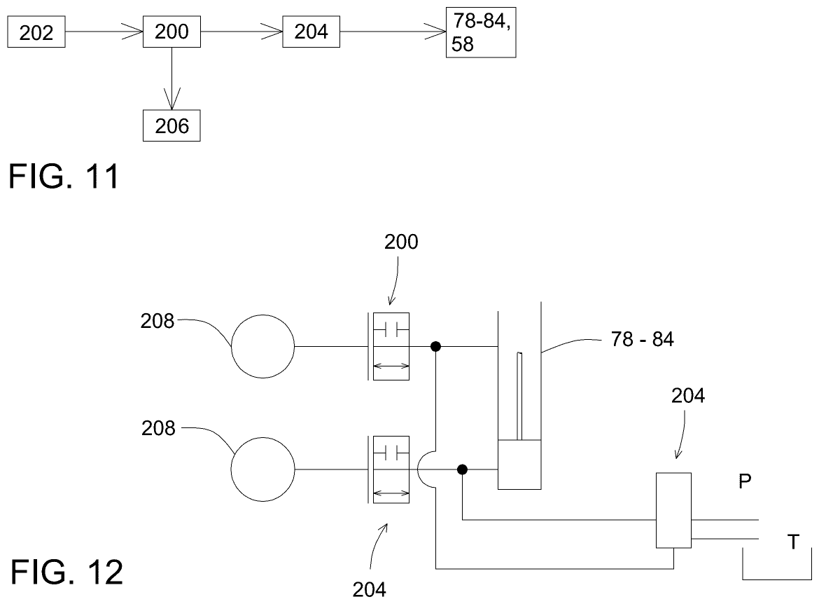

In FIGS. 11 and 12, some details on a possible control unit 200 for the actuators 78-84, 58 is shown. The control unit 200 is connected to a user interface 206 and to sensors 202. The user interface 206 enables an operator in cabin 20 to enter a desired orientation of the cabin 20 around the vertical axis, such that the operator can move the cabin 20 into a direction of interest, for example to view a tree for processing. Sensors 202 detect the orientation of chassis 12 in the forward and lateral directions 32, 30 and the electronic control unit 200 sends control signals to an electrohydraulic valve assembly 204 providing hydraulic pressure to actuators 78-84 and 58. These sensors 202 can be connected to the electronic control unit 200 by a CAN bus or another bus system, and also be used for controlling actuators (not shown) moving the boom 18, be it by control unit 200 or another controller. Actuator 58 can be controlled based on operator input provided via the user interface 206. The actuators 78-84 can thus be controlled based on the signals from the sensors 202 to keep the cabin 20 in a horizontal direction. Alternatively, or additionally, an automatic control of the actuators 78-84 and 58 is possible, such that the cabin 20 is automatically lifted up when trees are unloaded from the loadspace of a forwarder or to rotate and/or tilt the cabin 20 towards a grapple of a forwarder if needed. It is also possible to control the angles of the cabin 20 depending on the environment, for example whether on a flat ground or on a steep hill.

In FIG. 12, a possible valve assembly 204 for the linear actuators 78-84 is shown (each actuator 78-84) has its own valve assembly 204). The valve assembly 204 comprises pneumatic reservoirs 208 connected via proportional valves to the rod and bottom chambers of the double-acting linear actuators 78-84, allowing to adjust the dampening of the actuators 78-84 provided for the cabin 20, preferably adjustable by the operator via interface 206. In a simpler embodiment, the proportional valves could be replaced by fixed-size orifices. The hydraulic arrangement also comprises another valve connecting the chambers of the double-acting linear actuators 78-84 to a pump P or to a tank T to control the position of the of the double-acting linear actuators 78-84.

Terms of degree, such as “generally”, “substantially” or “approximately” are understood by those of ordinary skill to refer to reasonable ranges outside of a given value or orientation, for example, general tolerances or positional relationships associated with manufacturing, assembly, and use of the described embodiments.

While the above describes example embodiments of the present disclosure, these descriptions should not be viewed in a limiting sense. Rather, other variations and modifications may be made without departing from the scope and spirit of the present disclosure as defined in the appended claims.

What is claimed is:

1. A mechanism for movably mounting an upper structure of an off-road vehicle with respect to a chassis comprises:
a first part connected to the chassis or to the upper structure;
a second part connected to the upper structure or to the chassis;
a first linear actuator connected by spherical joints to the first part and the second part, respectively;
a second linear actuator connected by spherical joints to the first part and the second part, respectively, the first and second actuator spaced in a first direction,
a third linear actuator connected by spherical joints to the first part and the second part, respectively, spaced from the first and second actuator in a second direction transverse to the first direction,
a first link with a fixed length, connected between the first part and the second part, configured to pivot on a first end only around an axis extending parallel to the first direction and connected with its second end by a spherical joint,
and a second link connected to the first part and the second part, the second link restricting rotation of the second part against the first part within the plane spanned by the first and second direction.

2. The mechanism of claim 1, wherein the second link has a fixed length and is connected to the first and second part by respective spherical joints at positions spaced in the first direction.

3. The mechanism of claim 1 further comprising
a fourth actuator connected by spherical joints between the first part and the second part, the fourth actuator spaced from the third actuator in the first direction and from the first and second actuator in the second direction.

4. The mechanism of one of claim 1 wherein the first link is connected to the second part at a position at the center between the spherical joints mounting the first and second actuator to the second part.

5. The mechanism of claim 4, wherein the first link is connected to the first part at a position between the spherical joints mounting the third and fourth actuator to the first part.

6. The mechanism of claim 1, wherein the second or first part comprises a support element for the upper structure, the support element being rotatably mounted on the second or first part around a vertical axis by a rotation actuator.

7. The mechanism of claim 6 further comprising stops limiting axial movement of the support element with respect to the second or first part.

8. The mechanism of claim 1, wherein the first direction is transverse to a forward direction of the vehicle and the second direction extends in the forward direction of the vehicle.

9. The mechanism of claim 1, with a control arrangement connected to the actuators and configured to control at least two of the linear actuators to move jointly to control the inclination angle of the upper structure around an axis parallel to the first direction, to control at least two of the linear actuators to move in opposite directions to control the inclination angle of the upper structure around an axis parallel to the second direction and to control the linear actuators jointly to change the height of the upper structure.

10. The mechanism of claim 9, wherein the control arrangement is configured to compensate a rotation of the upper structure around the vertical axis caused by movement of at least one linear actuator and the geometry of the second link by controlling the rotation actuator.

11. The mechanism of claim 1, comprising stops between the first and second parts, assigned to the linear actuators and restricting the movement range of the actuators.

12. The mechanism of claim 11, wherein the stops comprise a slot interacting with a pin.

13. The mechanism of claim 1, wherein the actuators are hydraulic cylinders and connected or connectable to respective pneumatic reservoirs for dampening the upper structure.

14. The mechanism of claim 13, wherein a cross section of the connection between the cylinders and the pneumatic reservoirs is variable.

15. The mechanism of claim 1, wherein the upper structure comprises of an operator cabin. An off-road vehicle, in particular a forestry vehicle like a harvester or a forwarder with a mechanism according to one of the preceding claims, wherein the upper structure comprises or consists of an operator cabin.
